(19) United States
(12) Patent Application Publication
(10) Pub. No.: US 2023/0112280 A1
(43) Pub. Date: Apr. 13, 2023

(54) Portable Cooler

(71) Applicant: Sunjoy Industries Group Ltd., Galena, OH (US)

(72) Inventors: Sean Michael Banal, Galena, OH (US); Andrew Patrick Meier, Brookfield, WI (US)

(21) Appl. No.: 17/497,812

(22) Filed: Oct. 8, 2021

(51) Int. Cl. F25D 3/08; F25D 23/04; B62B 1/20; B62B 1/24; B62B 5/06; H02S 40/30; H02J 7/35

(52) U.S. Cl. CPC F25D 3/08; F25D 23/04; B62B 1/20; B62B 1/24; B62B 5/065; H02S 40/30; H02J 7/35; F25D 2400/38; B62B 2202/52; B62B 2204/06

(57) ABSTRACT

A portable cooler is disclosed herein. The portable cooler includes a cooler body portion, the cooler body portion defining an interior compartment configured to hold beverages and/or food items; and a cooler lid portion coupled to the cooler body portion, the cooler lid portion operable between open and closed states so as to allow a user to gain access to the beverages and/or food items in the interior compartment. In one or more embodiments, the portable cooler further includes a telescopic handle assembly pivotally coupled to the cooler body portion with an upper handle portion telescopically extendable from a lower handle portion. In one or more embodiments, the portable cooler further includes a solar panel disposed on the cooler lid portion, and an electrical power output device electrically coupled to the solar panel for transmitting electrical energy generated by the solar panel to an electrical device.

### CROSS-REFERENCE TO RELATED APPLICATIONS

Not Applicable.

### STATEMENT REGARDING FEDERALLY SPONSORED RESEARCH OR DEVELOPMENT

Not Applicable.

### NAMES OF THE PARTIES TO A JOINT RESEARCH AGREEMENT

Not Applicable.

### INCORPORATION BY REFERENCE OF MATERIAL SUBMITTED ON A COMPACT DISK

Not Applicable.

### BACKGROUND OF THE INVENTION

### 1. Field of the Invention

The invention generally relates to a portable cooler. More particularly, the invention relates to a portable cooler that is easier to pull and transport to different locations, and may further include a built-in solar panel for powering electronic devices.

### 2. Background

Conventional coolers are known, which use a storage compartment with ice to keep food and/or beverage items cool when a refrigerator is not available (e.g., in an outdoor environment). However, because many of these conventional coolers are designed to hold a relatively large quantity of food and/or beverage items, these coolers tend to be heavy and difficult to transport from place to place, particularly when the coolers are fully loaded with food and/or beverage items. In addition, these conventional coolers do not have any power source for powering electronic devices when a user is located at a remote location (e.g., in a campground or at the beach).

Therefore, what is needed is a portable cooler that is easier to pull and transport to different locations, even when the cooler is loaded with food and/or beverage items. In addition, a portable cooler is needed that has a built-in solar panel for powering electronic devices when a user is located at a remote location that does not have conventional power sources.

### BRIEF SUMMARY OF EMBODIMENTS OF THE INVENTION

Accordingly, the present invention is directed to a portable cooler that substantially obviates one or more problems resulting from the limitations and deficiencies of the related art.

In accordance with one or more embodiments of the present invention, there is provided a portable cooler that includes a cooler body portion, the cooler body portion defining an interior compartment configured to hold beverages and/or food items; a cooler lid portion coupled to the cooler body portion, the cooler lid portion operable between open and closed states so as to allow a user to gain access to the beverages and/or food items in the interior compartment; and a telescopic handle assembly coupled to the cooler body portion, the telescopic handle assembly comprising an upper handle portion and a lower handle portion, the lower handle portion being pivotally coupled to a side wall of the cooler body portion, and the upper handle portion of the telescopic handle assembly being telescopically extendable from the lower handle portion of the telescopic handle assembly so as to facilitate a transporting of the portable cooler by the user.

In a further embodiment of the present invention, the cooler body portion defines at least one first handle recess and the cooler lid portion defines at least one second handle recess, and the telescopic handle assembly is pivotably displaceable between a stowed position and an operative position. In the stowed position, the telescopic handle assembly is received within the at least one first handle recess in the cooler body portion and the at least one second handle recess in the cooler lid portion. In the operative position, the telescopic handle assembly extends outwardly from the side wall of the cooler body portion so that the telescopic handle assembly is able to be readily grasped by the user.

In yet a further embodiment, the upper handle portion of the telescopic handle assembly comprises a release button for disengaging a locking mechanism that prevents the telescopic extension of the upper handle portion from the lower handle portion of the telescopic handle assembly.

In still a further embodiment, the cooler body portion comprises an inner tank portion received within an outer shell portion, a portion of the inner tank portion being spaced apart from the outer shell portion so as to define a cavity therebetween comprising an insulating material, the insulated cavity configured to minimize heat transfer into the interior compartment of the portable cooler.

In yet a further embodiment, the inner tank portion is formed using an injection molding process and the outer shell portion is formed using a blow molding process.

In still a further embodiment, the cooler lid portion comprises at least one beverage container recess disposed in a top surface thereof, the at least one beverage container recess configured to receive a base portion of a beverage container so as to prevent the beverage container from being knocked over by the user.

In yet a further embodiment, the portable cooler further comprises at least one latching device for maintaining the cooler lid portion in a closed position relative to the cooler body portion, the at least one latching device comprising protruding prong members for allowing the at least one latching device to be used as a bottle opener and/or can opener by the user.

In still a further embodiment, the portable cooler further comprises a pair of lifting handles for facilitating a lifting of the portable cooler by the user, a first one of the lifting handles being disposed on a first end of the cooler body portion, and a second one of the lifting handles being disposed on a second end of the cooler body portion that is opposite to the first end of cooler body portion.

In yet a further embodiment, the first one or the second one of the lifting handles is partially circumscribed by the telescopic handle assembly when the telescopic handle assembly is in a stowed position.

In still a further embodiment, the cooler body portion further comprises a removable partition member that divides the interior compartment into a plurality of sub-compartments, and one or more interior walls of the cooler body portion comprise a slot for slidably receiving an edge portion of the removable partition member therein.

In yet a further embodiment, the cooler body portion further comprises a removable tray member, a portion of a peripheral edge of the removable tray member configured to be supported on a peripheral ledge disposed on one or more sides of the interior compartment of the cooler body portion.

In still a further embodiment, the portable cooler further comprises at least one wheel disposed near a bottom of the cooler body portion for enabling the portable cooler to be rolled while being transported by the user, the at least one wheel comprising an inner rim portion formed from a first polymeric material and an outer tire portion formed from a second polymeric material, the second polymeric material being more flexible than the first polymeric material.

In yet a further embodiment, the cooler body portion has a first end and a second end, the first end of the cooler body portion being oppositely disposed relative to the second end of the cooler body portion, the telescopic handle assembly being disposed on the first end of the cooler body portion and the at least one wheel being disposed proximate to the second end of the cooler body portion; whereby the user is able to lift up the first end of the portable cooler using the telescopic handle assembly, and then pull the portable cooler along the ground while the second end of the portable cooler is supported on the at least one wheel.

In still a further embodiment, the portable cooler further comprises a solar panel disposed on the cooler lid portion, the solar panel configured to generate electrical energy from a light source; and an electrical power output device electrically coupled to the solar panel, the electrical power output device configured to transmit the electrical energy generated by the solar panel to an electrical device for recharging or powering the electrical device.

In yet a further embodiment, the solar panel is recessed mounted on the cooler lid portion such that a top surface of the solar panel is generally flush with a top surface of the cooler lid portion.

In still a further embodiment, the electrical power output device comprises an electrical receptacle configured to receive an electrical connector that is electrically coupled to the electrical device.

In accordance with one or more other embodiments of the present invention, there is provided a portable cooler that includes a cooler body portion, the cooler body portion defining an interior compartment configured to hold beverages and/or food items; a cooler lid portion coupled to the cooler body portion, the cooler lid portion operable between open and closed states so as to allow a user to gain access to the beverages and/or food items in the interior compartment; a solar panel disposed on the cooler lid portion, the solar panel configured to generate electrical energy from a light source; and an electrical power output device electrically coupled to the solar panel, the electrical power output device configured to transmit the electrical energy generated by the solar panel to an electrical device for recharging or powering the electrical device.

In a further embodiment of the present invention, the solar panel is recessed mounted on the cooler lid portion such that a top surface of the solar panel is generally flush with a top surface of the cooler lid portion.

In yet a further embodiment, the electrical power output device comprises an electrical receptacle configured to receive an electrical connector that is electrically coupled to the electrical device.

In still a further embodiment, the electrical receptacle is in a form of a universal serial bus (USB) port for receiving a USB plug that is coupled to the electrical device by an electrical cord.

It is to be understood that the foregoing general description and the following detailed description of the present invention are merely exemplary and explanatory in nature. As such, the foregoing general description and the following detailed description of the invention should not be construed to limit the scope of the appended claims in any sense.

### BRIEF DESCRIPTION OF THE SEVERAL VIEWS OF THE DRAWINGS

The invention will now be described, by way of example, with reference to the accompanying drawings, in which:

FIG. 1 is a side-top perspective view of a portable cooler, according to an illustrative embodiment of the invention;

FIG. 2 is a first side elevational view of the portable cooler of FIG. 1;

FIG. 3 is a second side elevational view of the portable cooler of FIG. 1;

FIG. 4 is a rear elevational view of the portable cooler of FIG. 1;

FIG. 5 is a front elevational view of the portable cooler of FIG. 1;

FIG. 6 is a top plan view of the portable cooler of FIG. 1;

FIG. 7 is a bottom plan view of the portable cooler of FIG. 1;

FIG. 8 is an exploded perspective view of the portable cooler of FIG. 1;

FIG. 9 is a rear-top perspective view of the portable cooler of FIG. 1;

FIG. 10 is an enlarged, partial perspective view of the electrical device charging receptacle disposed on the top of the portable cooler in FIG. 9 (Detail “A”);

FIG. 11 is another side-top perspective view of the portable cooler of FIG. 1, wherein the lid portion of the cooler is in an open position and the telescopic handle assembly is rotated downward into an operative position;

FIG. 12 is yet another side-top perspective view of the portable cooler of FIG. 1, wherein the telescopic handle assembly is in an operative position so that the portable cooler is able to be pulled by a user;

FIG. 13 is an enlarged, partial perspective view of the lid portion of the portable cooler in FIG. 12, wherein a beverage container is shown inserted into one of the cup recesses in the lid portion of the cooler (Detail “B”);

FIG. 14 is still another side-top perspective view of the portable cooler of FIG. 1, wherein one of the lid latches is depicted in a disengaged position where the bottle opener portion of the lid latch is accessible;

FIG. 15 is an enlarged, partial perspective view of the disengaged lid latch of the portable cooler in FIG. 14, wherein the bottle opener portion of the lid latch is being used for removing a bottle cap from a bottle (Detail “C”);

FIG. 16 is yet another side-top perspective view of the portable cooler of FIG. 1, wherein the extendable nature of the telescopic handle assembly is illustrated;

FIG. 17 is another rear-top perspective view of the portable cooler of FIG. 1;

FIG. 18 is still another side-top perspective view of the portable cooler of FIG. 1, wherein the lid portion of the cooler is in an open position so as to illustrate the manner in which the interior components of the portable cooler are inserted into the interior cooler compartment;

FIG. 19 is an enlarged, partial perspective view of one of the wheels of the portable cooler in FIG. 18 (Detail “D”);

FIG. 20 is a bottom-side perspective view of the portable cooler of FIG. 1;

FIG. 21 is a transverse sectional view of the portable cooler of FIG. 1, wherein the section is generally cut along the cutting-plane line A-A in FIG. 3; and

FIG. 22 is an enlarged, partial sectional view of the portable cooler in FIG. 21, wherein the interface between the cooler body and the lid portion is depicted (Detail “E”);

Throughout the figures, the same parts are always denoted using the same reference characters so that, as a general rule, they will only be described once.

### DETAILED DESCRIPTION OF EMBODIMENTS OF THE INVENTION

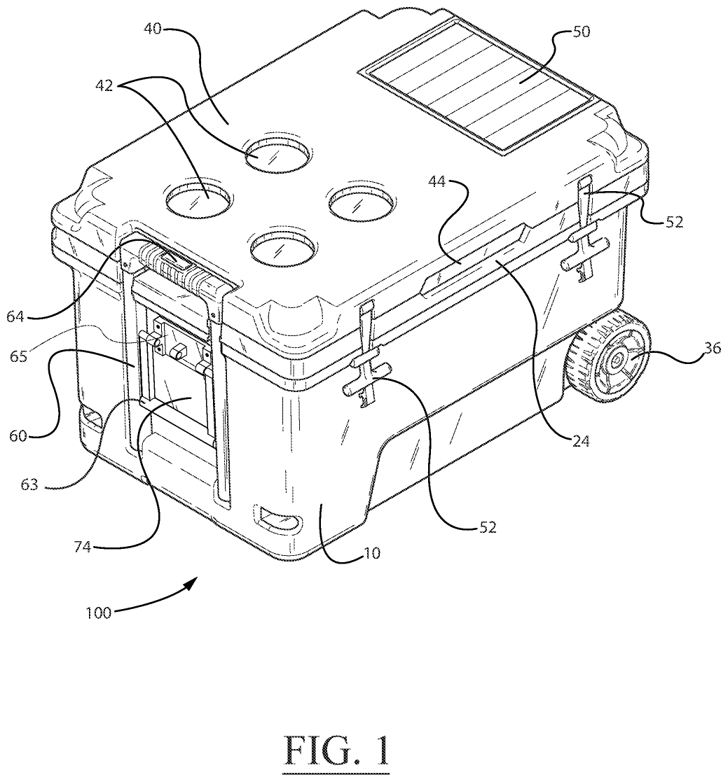

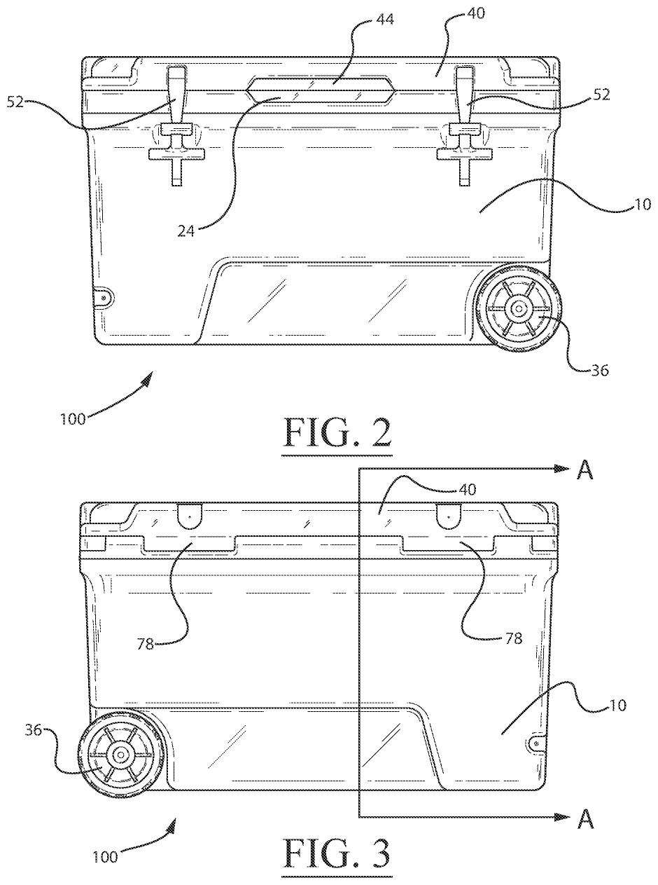

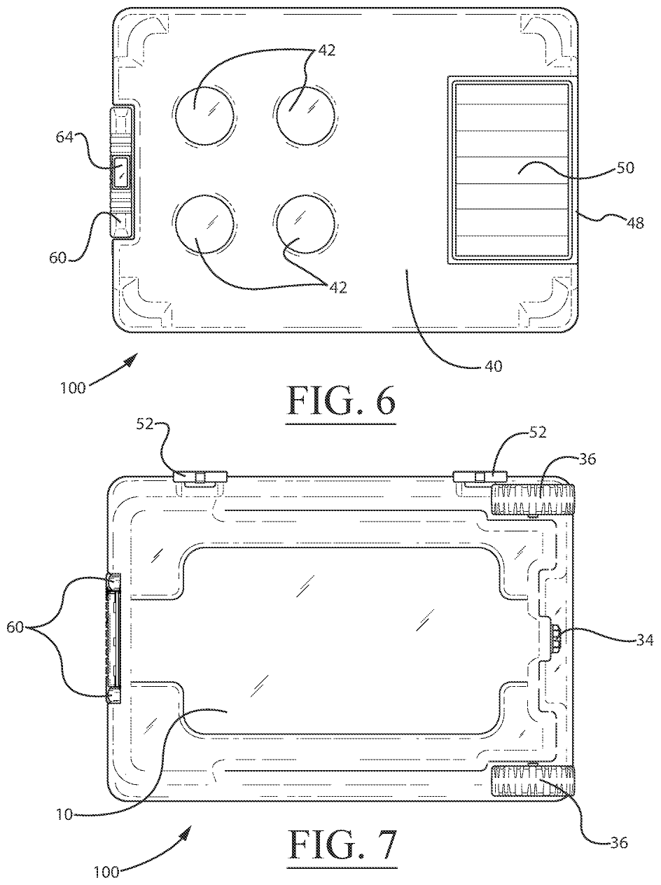

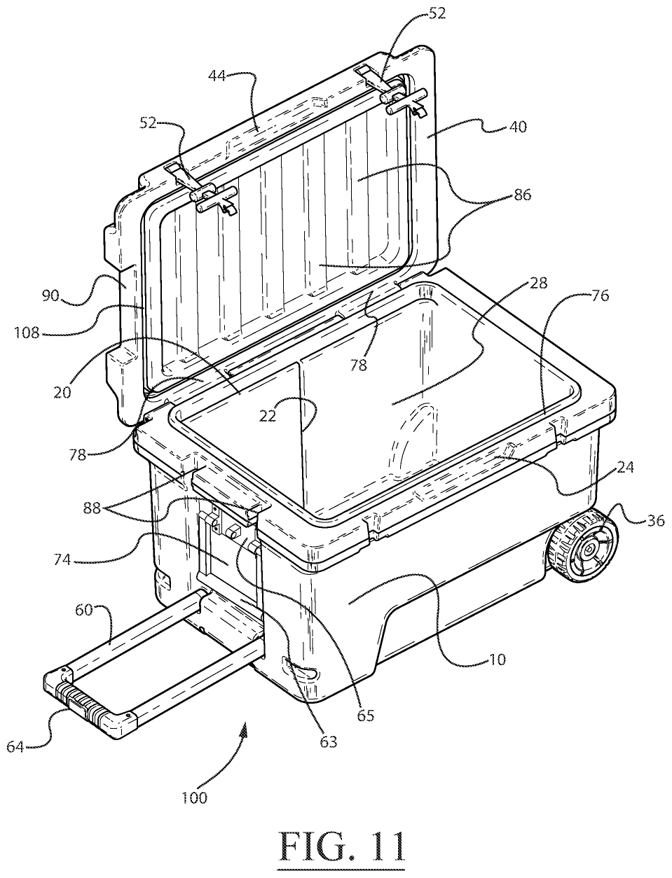

An illustrative embodiment of a portable cooler is seen generally at 100 in FIGS. 1-8. In particular, referring initially to FIGS. 1, 8, and 11, it can be seen that the illustrative portable cooler 100 generally comprises a cooler body portion 10, the cooler body portion 10 defining an interior compartment 28 configured to hold beverages and/or food items (see FIG. 11); and a cooler lid portion 40 coupled to the cooler body portion 10, the cooler lid portion 40 operable between open and closed states (see FIGS. 1 and 11) so as to allow a user to gain access to the beverages and/or food items in the interior compartment 28.

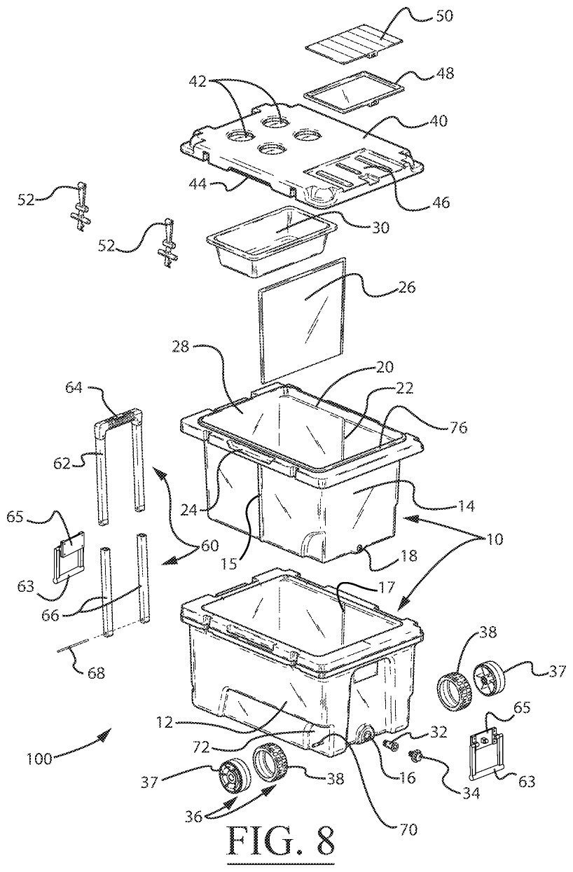

In the illustrative embodiment, turning to the exploded view in FIG. 8, it can be seen that the cooler body portion 10 comprises an inner tank portion 14 received within an outer shell portion 12. As best shown in the transverse section view of FIG. 21, a portion of the inner tank portion 14 is spaced apart from the outer shell portion 12 so as to define a cavity 104 therebetween filled with an insulating material (e.g., a polyurethane foam material). The insulated cavity 104 is configured to minimize heat transfer into the interior compartment 28 of the portable cooler 100. In an alternative embodiment, the cavity 104 between the outer shell portion 12 and the inner tank portion 14 may simply comprise an air space or air gap without any insulating material.

In the illustrative embodiment, with reference to the exploded view of FIG. 8, it can be seen that the inner tank portion 14 is provided with guide ribs 15 on opposite sides thereof that engage with corresponding slots 17 on the interior of the outer shell portion 12 so as to ensure the proper alignment between the components 12, 14.

In the illustrative embodiment, the inner tank portion 14 is formed using an injection molding process and the outer shell portion 12 is formed using a blow molding process. Advantageously, the combination of the injection-molded inner tank portion 14 and the blow-molded outer shell portion 12 results in a construction that is similar to an assembly formed using a rotational molding process, but without the complexity of the rotational molding process so that the portable cooler 100 is able to be produced in a highly efficient manner, while minimizing cost. In the illustrative embodiment, the outer shell portion 12 of the portable cooler 100 is formed from polyethylene, while the inner tank portion 14 is formed from polypropylene.

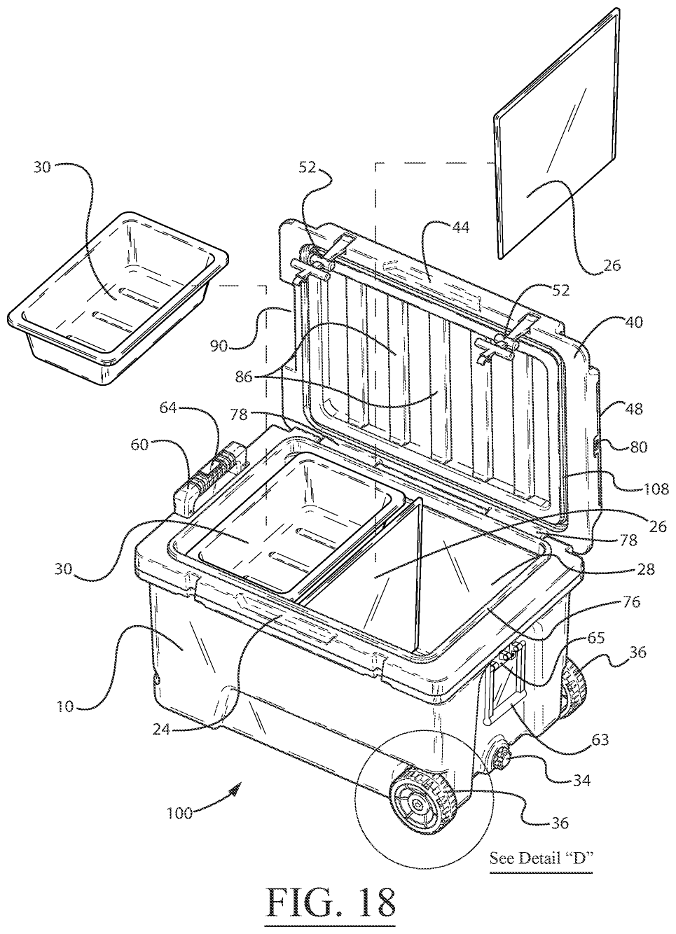

Referring collectively to FIGS. 8 and 18, in the illustrative embodiment, the cooler body portion 10 further comprises a removable partition member 26 that divides the interior compartment 28 into a plurality of sub-compartments (e.g., two sub-compartments—see FIG. 18). As shown in FIGS. 8 and 11, the oppositely disposed interior side walls of the inner tank portion 14 may be provided with vertically extending partition slots 22 disposed therein for slidably receiving opposed edge portions of the removable partition member 26 therein. In the illustrative embodiment, the outer periphery of the removable partition member 26 may be provided with a flexible sealing member so as to provide a generally tight fit with the partition slots 22 in the interior side walls of the inner tank portion 14. Advantageously, the removable partition member 26 allows different types of food and/or beverage items being stored in the cooler 100 to be separated from one another. If a single storage compartment is desired for large food and/or beverage items, the partition member 26 can simply be removed from the interior compartment 28 of the portable cooler 100.

Also, as shown in the illustrative embodiment of FIGS. 8 and 18, the cooler body portion 10 further comprises a removable tray member 30 with a peripheral edge. As best shown in FIG. 18, opposite sides of the peripheral edge of the removable tray member 30 are configured to be supported on a peripheral ledge 20 disposed on opposite sides of the interior compartment 28 of the cooler body portion 10. More specifically, as shown in FIGS. 8 and 18, in the illustrative embodiment, opposite side portions of the upper interior rim of the inner tank portion 14 are provided with the inner ledge 20 for supporting the removable tray member 30. Advantageously, the removable tray member 30 allows smaller food and/or beverage items to be conveniently stored and accessed in the cooler 100.

In other embodiments, the portable cooler 100 may be provided with other drop-in accessories that may be supported on the peripheral ledge 20, similar to the removable tray member 30. For example, one such drop-in accessory may comprise a removable basket that is similar in size to the removable tray member 30.

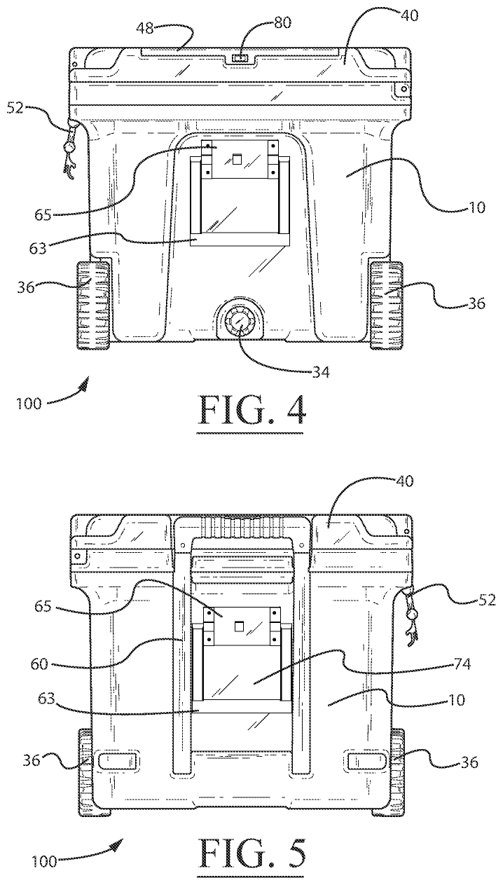

With combined reference to FIGS. 4, 8, 9, 18, and 20, it can be seen that, in the illustrative embodiment, the cooler body portion 10 comprises a removable drain plug 34 for allowing water to be drained from the interior compartment 28 of the inner tank portion 14 (e.g., when ice in the cooler melts, or during the cleaning of the cooler 100, etc.). More specifically, in the illustrative embodiment, the removable drain plug 34 is threadingly received within the inner drain sleeve 32, and is able to be removed from the inner drain sleeve 32 by rotating the drain plug 34 in a loosening direction. As best shown in the exploded view of FIG. 8, the inner drain sleeve 32 is received within the drain aperture 16 of the outer shell portion 12 and the drain aperture 18 of the inner tank portion 14. In the illustrative embodiment, when the drain plug 34 is removed, any residual water in the interior compartment 28 of the inner tank portion 14 is able to be drained by upwardly lifting the end of the cooler 100 that is opposite to the inner drain sleeve 32 so that the water collects in the bottom portion of the interior compartment 28 proximate to the drain.

In the illustrative embodiment, referring collectively to FIGS. 1, 3, 11, and 18, it can be seen that, in the illustrative embodiment, the cooler lid portion 40 is pivotally connected to the cooler body portion 10 by pair of spaced-apart hinges 78 so as to allow the cooler lid portion 40 to be rotated between its open state (refer to FIGS. 11 and 18) and its closed state (see FIG. 1). In the illustrative embodiment, as shown in FIGS. 1, 3, 11, and 18, the portable cooler 100 is provided with a pair of spaced-apart latching devices 52 for maintaining the cooler lid portion 40 in a closed position relative to the cooler body portion 10. In order to open the cooler lid portion 40, a user initially disengages the latching devices 52 by grasping and rotating each of the latching devices 52 outwardly from the cooler body portion 10. After which, the user may insert his or her hand in the lid hand notch defined by the lower hand recess 24 formed in the cooler body portion 10 and the upper hand recess 44 formed in the cooler lid portion 40, and then lift up on the cooler lid portion 40 and rotate the lid 40 in a counter-clockwise direction until reaching the open position depicted in FIGS. 11 and 18.

In the illustrative embodiment, referring to FIGS. 11 and 18, it can be seen that the underside of the cooler lid portion 40 is provided with a plurality of spaced-apart rib members 86 for increasing the structurally rigidity of the lid 40. As best shown in the transverse section view of FIG. 21, the interior wall portion of the lid 40 is spaced apart from the outer wall portion of the lid 40 so as to define a cavity 106 therebetween filled with an insulating material (e.g., a polyurethane foam material). Similar to that described above for the insulated cavity 104, the insulated cavity 106 is configured to minimize heat transfer into the interior compartment 28 of the portable cooler 100. In an alternative embodiment, the cavity 106 between the interior wall portion and the outer wall portion of the lid 40 may simply comprise an air space or air gap without any insulating material.

In the illustrative embodiment, the cooler lid portion 40 is formed using a blow molding process. Also, in the illustrative embodiment, the cooler lid portion 40 of the portable cooler 100 is formed from polyethylene.

Referring again to FIGS. 11 and 18, in the illustrative embodiment, the underside of the cooler lid portion 40 is provided with a peripheral groove 108 that circumscribes the spaced-apart rib members 86. When the cooler lid 40 is closed, the peripheral groove 108 is configured to matingly engage with the peripheral protrusion 76 on the top rim of the cooler body portion 10 so as to provide a seal for the interior compartment 28 of the portable cooler 100. Also, in the illustrative embodiment, the peripheral groove 108 of the cooler lid 40 may contain a deformable seal member that is compressed by peripheral protrusion 76 of the cooler body portion 10 so as to further enhance the sealing engagement between the cooler lid portion 40 and the cooler body portion 10.

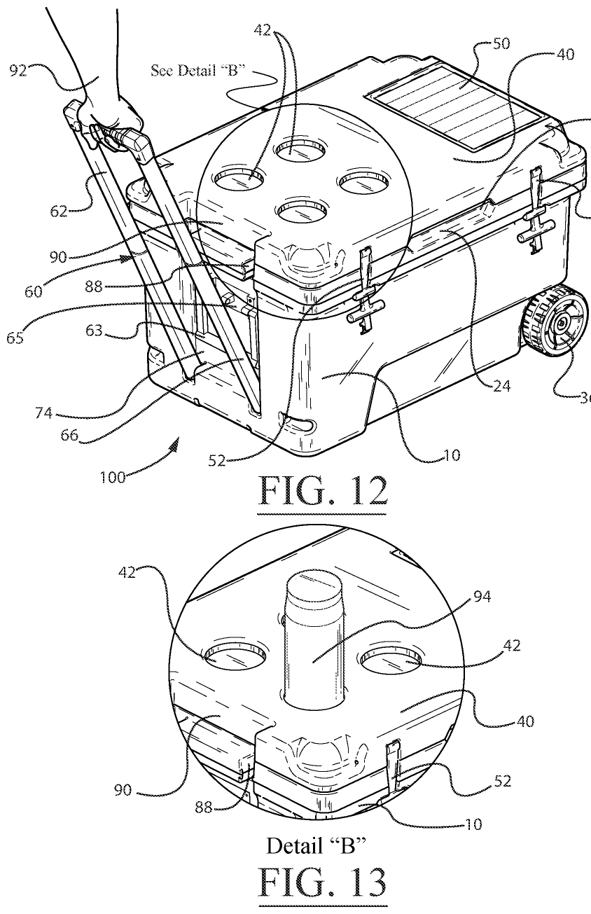

Turning to FIGS. 12 and 13, in the illustrative embodiment, the cooler lid portion 40 may comprise a plurality of beverage container recesses 42 (e.g., four (4) cup holder recesses 42) disposed in a top surface thereof. Each of the beverage container recesses 42 are configured to receive a base portion of a beverage container so as to prevent the beverage container from being knocked over by the user. For example, as illustrated in FIG. 13, one of the beverage container recesses 42 is depicted with a beverage container 94 received therein.

In an alternative embodiment, the portable cooler 100 may be provided with a split lid or double lid, rather than a single lid portion 40. For example, in the split lid or double lid configuration of the portable cooler 100, the first lid portion may allow access to the first compartment on the left side of the removable partition member 26, and the second lid portion may allow access to the second compartment on the right side of the removable partition member 26.

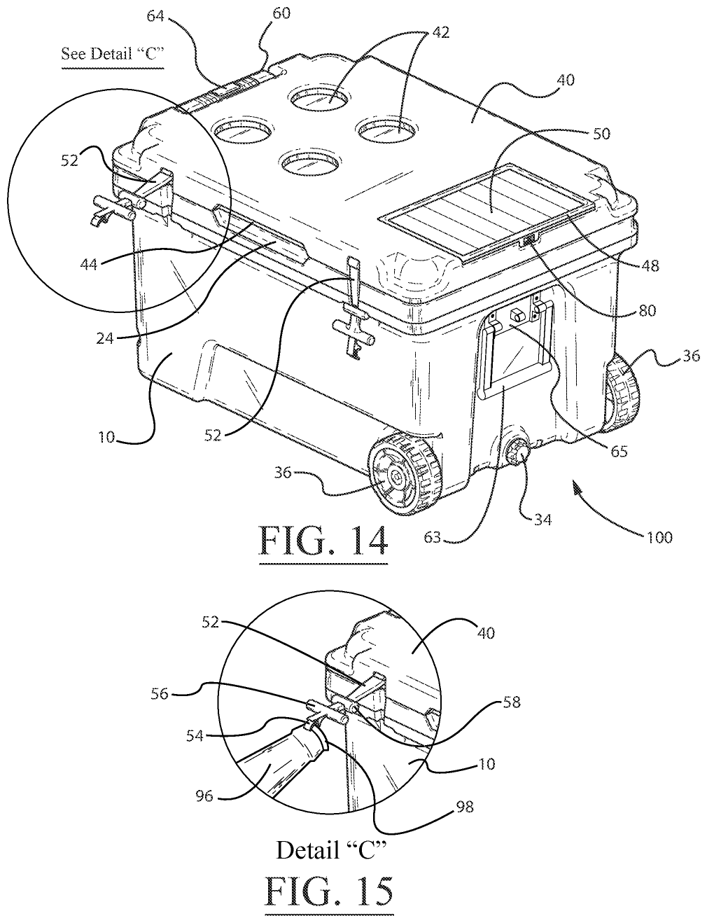

Also, in the illustrative embodiment, with reference to FIGS. 14 and 15, each of the lid latching devices 52 comprises protruding prong members (see FIG. 15) for allowing each latching device 52 to be used as a bottle opener and/or can opener by the user. For example, as shown in FIG. 15, the protruding prong members of the latching device 52 are being used to remove the bottle cap 98 from the bottle 96. In the illustrative embodiment, as shown in FIG. 15, each latching device 52 comprises a bottle opener portion 54 for removing a bottle cap, a handle portion 56 for grasping by a user to disengage the latch 52, and a securement portion 58 for engaging with the underside of the peripheral rim of the cooler body portion 10 (see FIGS. 1 and 12) for securing the cooler lid 40 in a closed position. The bottle opener portion 54 of the latching device 52 also is able to be used to lift a lid tab on a can so as to facilitate the opening of a can as well as a bottle.

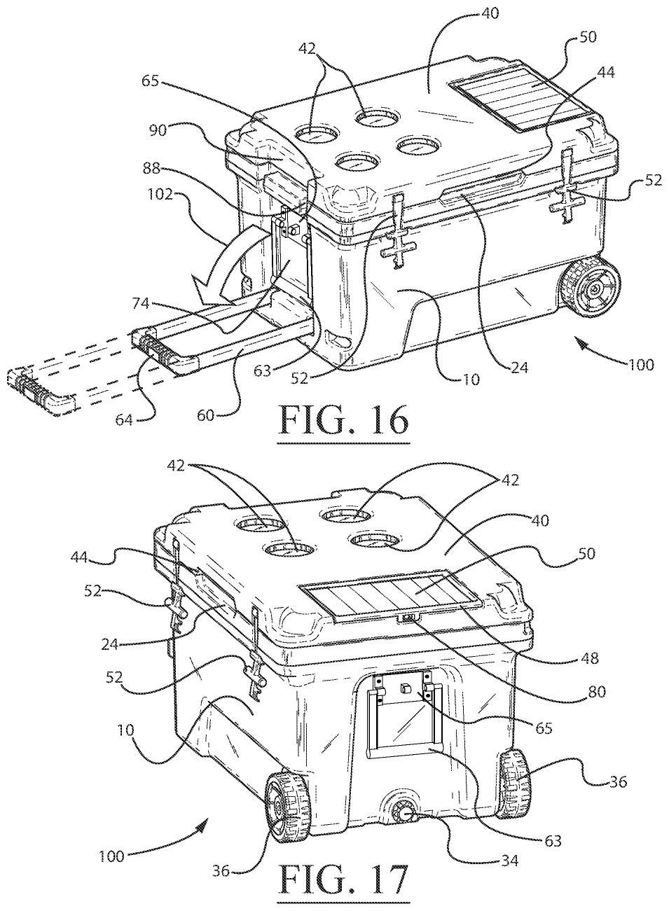

Now, with combined reference to FIGS. 1, 8, 12, and 16, it can be seen that, in the illustrative embodiment, the portable cooler 100 further comprises a telescopic handle assembly 60 coupled to the cooler body portion 10. Advantageously, the retractable configuration of the handle assembly 60 allows it to be compactly stowed on the front wall of the portable cooler 100 when the handle assembly 60 is not being used. More specifically, as shown in FIGS. 8 and 12, the telescopic handle assembly 60 comprises an upper U-shaped handle portion 62 configured to be grasped by a user and a lower handle portion 66 that is pivotally coupled to the front wall of the cooler body portion 10. As depicted in FIGS. 12 and 16, the upper U-shaped handle portion 62 of the telescopic handle assembly 60 is telescopically extendable from the lower handle portion 66 of the telescopic handle assembly 60 so as to facilitate a transporting of the portable cooler 100 by the user. For example, a hand 92 of a user is shown grasping the upper U-shaped handle portion 62 of the telescopic handle assembly 60 so that the portable cooler 100 is able to be pulled along the ground.

Referring again to FIGS. 1, 8, 12, and 16, it can be seen that the cooler body portion 10 has a first end (e.g., a front end) and a second end (e.g., a rear end). The first end of the cooler body portion 10 is oppositely disposed relative to the second end of the cooler body portion 10. In the illustrative embodiment, the telescopic handle assembly 60 is disposed on the first end (e.g., a front end) of the cooler body portion 10.

In the illustrative embodiment, referring to FIGS. 11, 12, and 16, the cooler body portion 10 defines a pair of first spaced-apart handle recesses 88 and the cooler lid portion 40 defines a second handle recess 90. As diagrammatically represented by the curved arrow 102 in FIG. 16, the telescopic handle assembly 60 is pivotably displaceable between a stowed position and an operative position (i.e., the handle assembly 60 is able to be rotated in a counter-clockwise direction indicated by the arrow 102 from its stowed position to its operative position). As shown in FIG. 8, in the illustrative embodiment, the lower tubular members of the handle assembly 60 are pivotably coupled to the cooler body portion 10 by a pin member 68. In the stowed position (e.g., as shown in FIGS. 1 and 5), the telescopic handle assembly 60 is received within the pair of first spaced-apart handle recesses 88 in the cooler body portion 10 and the second handle recess 90 in the cooler lid portion 40. More specifically, the handle member of the handle assembly 60 is received within the second handle recess 90 in the rim of the cooler lid portion 40 (refer to FIG. 1), while the tubular members of the handle assembly 60 are received in respective spaced-apart handle recesses 88 in the rim of the cooler body portion 10. In the operative position (e.g., as shown in FIG. 12), the telescopic handle assembly 60 extends outwardly from the side wall of the cooler body portion 10 so that the telescopic handle assembly 60 is able to be readily grasped by the user (e.g., by the hand 92 of the user in FIG. 12).

With reference to FIGS. 1, 11, and 16, it can be seen that, in the illustrative embodiment, the upper U-shaped handle portion 62 of the telescopic handle assembly 60 comprises a release button 64 for disengaging a locking mechanism that prevents the telescopic extension of the upper U-shaped handle portion 62 from the lower handle portion 66 of the telescopic handle assembly (i.e., from the lower tubular members 66 of the handle assembly 60). In the illustrative embodiment, when a user wants to extend the upper U-shaped handle portion 62 from the lower handle portion 66, he or she presses the release button 64, which disengages the handle locking mechanism, and allows the upper U-shaped handle portion 62 to be pulled from the lower handle portion 66.

Next, referring primarily to FIGS. 1, 4, 5, and 8 of the illustrative embodiment, it can be seen that the portable cooler 100 further comprises a pair of lifting handles 63 for facilitating a lifting of the portable cooler 100 by the user (i.e., a user can grasp the lifting handles 63 with respective hands in order to lift up the portable cooler 100). As shown in FIGS. 1, 4, 5, and 8, a first one of the lifting handles 63 is disposed on a first end of the cooler body portion 10, and a second one of the lifting handles 63 is disposed on a second end of the cooler body portion 10 that is opposite to the first end of cooler body portion 10. In the illustrative embodiment, each lifting handle 63 is attached to its respective end of the cooler body portion 10 by a handle base portion 65. In their operative positions, each of the lifting handle 63 are able to be rotated upwardly and outwardly from their respective ends of the cooler body portion 10 about a pivotal axis passing through the handle base portion 65.

As shown in FIGS. 1 and 5, in the illustrative embodiment, the lifting handle 63 on the front end of the cooler body portion 10 is partially circumscribed by the telescopic handle assembly 60 when the telescopic handle assembly 60 is in a stowed position (i.e., in its stowed position, the telescopic handle assembly 60 circumscribes the lifting handle 63 on three (3) sides). Each lifting handle 63 is recess-mounted within a handle recess 74 formed in a respective end of the outer shell portion 12 of the cooler body portion 10.

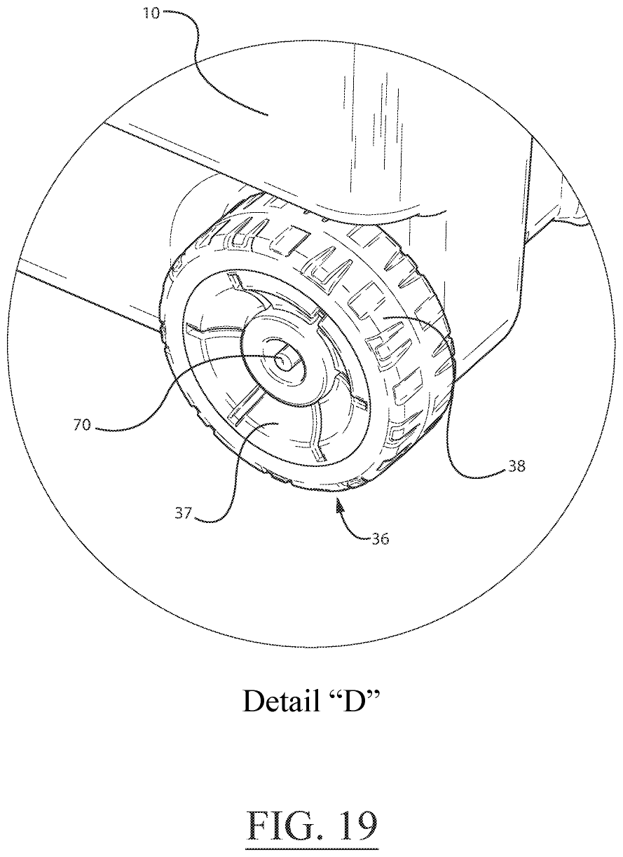

In the illustrative embodiment, referring collectively to FIGS. 1 and 18-20, it can be seen that the portable cooler 100 further comprises a plurality of wheels 36 (e.g., a pair of wheels 36) disposed near a bottom of the cooler body portion 10 for enabling the portable cooler 100 to be rolled while being transported by the user. As shown in the detail view of FIG. 19, each of the wheels 36 includes an inner rim portion 37 formed from a first polymeric material and an outer tire portion 38 formed from a second polymeric material. In the illustrative embodiment, the second polymeric material is more flexible than the first polymeric material. For example, the first polymeric material may comprise polypropylene, and the second polymeric material may comprise a thermoplastic rubber (TPR).

As described above, in the illustrative embodiment, the telescopic handle assembly 60 is disposed on the first end (e.g., a front end) of the cooler body portion 10. In FIGS. 1, 11, and 12, it can be seen that the pair of wheels 36 are disposed proximate to the second end (e.g., a rear end) of the cooler body portion 10 so that the user is able to lift up the first end of the portable cooler 100 using the telescopic handle assembly 60, and then pull the portable cooler 100 along the ground while the second end of the portable cooler 100 is supported on the pair of wheels 36.

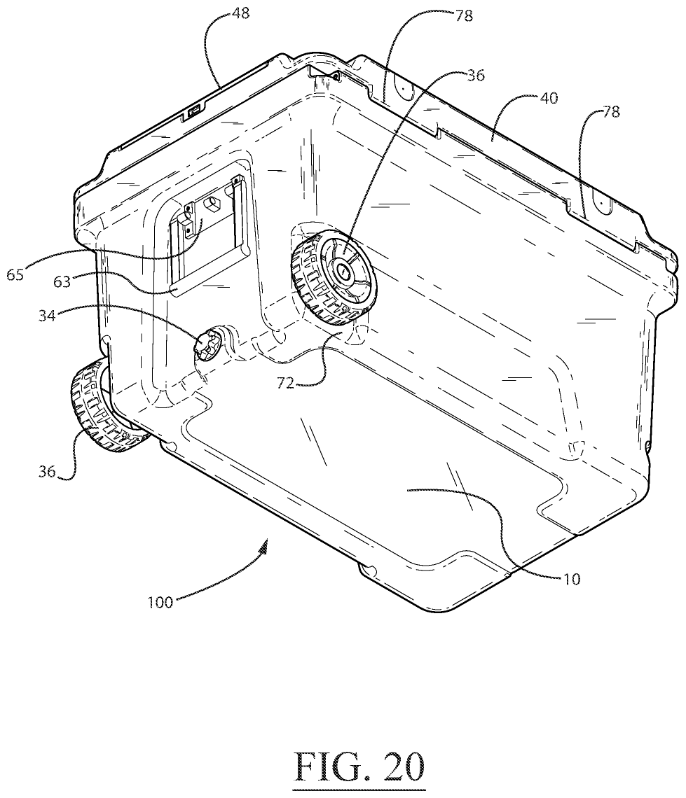

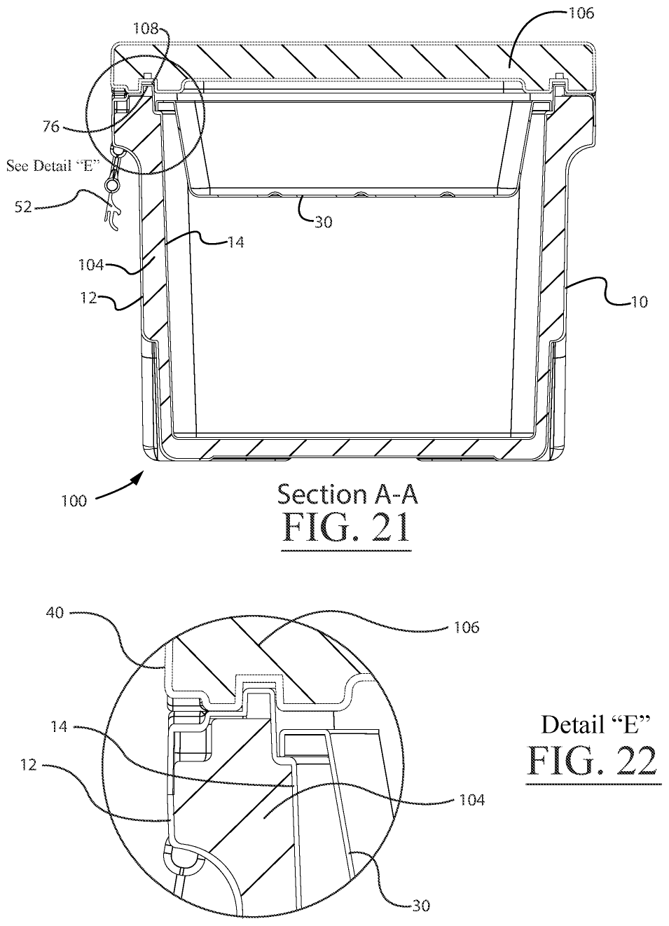

Turning to FIGS. 8 and 20 of the illustrative embodiment, it can be seen that each wheel 36 is attached to the cooler body portion 10 by means of a wheel shaft 70. In the illustrative embodiment, each wheel shaft 70 is affixed to a respective side wall of the cooler body portion 10, and each wheel 36 pivots about its respective wheel shaft 70. Also, as shown in the illustrative embodiment of FIGS. 8 and 20, each side of the cooler body portion 10 is provided with a wheel recess 72 for accommodating a respective one of the wheels 36. Advantageously, the wheel recesses 72 minimize the amount that the wheels 36 protrude outwardly from the sides of the cooler body portion 10.

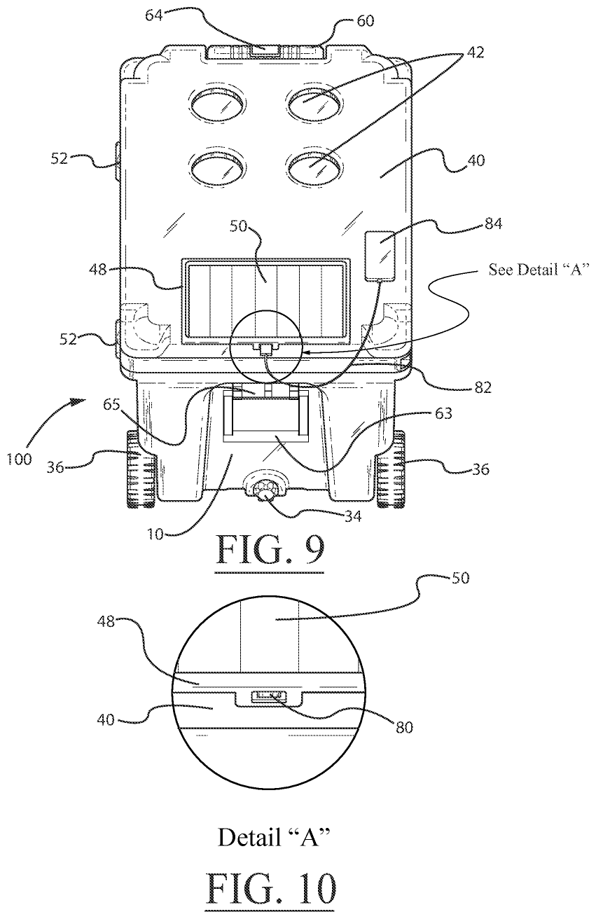

Now, turning to FIGS. 1, 8-10, and 17 of the illustrative embodiment, it can be seen that the portable cooler 100 further comprises a solar panel 50 disposed on the cooler lid portion 40 and an electrical power output device 80 electrically coupled to the solar panel 50. The solar panel 50 of the portable cooler 100 is configured to generate electrical energy from a light source (e.g., from sunlight). The electrical power output device 80 is configured to transmit the electrical energy generated by the solar panel 50 to an electrical device (e.g., a smartphone) for recharging or powering the electrical device. For example, as shown in FIG. 9, the solar panel 50 is being used to recharge the battery of the smartphone 84.

In the illustrative embodiment, as shown in FIGS. 1 and 8, the solar panel 50 is recessed mounted on the cooler lid portion 40 such that a top surface of the solar panel 50 is generally flush with a top surface of the cooler lid portion 40. More specifically, referring to the exploded view of FIG. 8, it can be seen that the cooler lid portion 40 is provided with a solar panel recess 46 for accommodating the recess mounting of the solar panel 50. With combined reference to FIGS. 8 and 9 of the illustrative embodiment, it can be seen that solar panel 50 is supported within the solar panel base frame 48, and then mounted within the solar panel recess 46 of the cooler lid portion 40.

Referring again to FIGS. 9 and 10, in the illustrative embodiment, the electrical power output device 80 comprises an electrical receptacle configured to receive an electrical connector that is electrically coupled to an electrical device. More specifically, in the illustrative embodiment, the electrical receptacle 80 is in a form of a universal serial bus (USB) port for receiving a USB plug that is coupled to the electrical device (e.g., smartphone 84) by an electrical cord. For example, as shown in FIG. 9, the USB plug of the smartphone charging cord 82 connected to the smartphone 84 may be inserted into the USB port 80 so that the battery of the smartphone 84 is able to be recharged by the electrical power generated by the solar panel 50.

In the illustrative embodiment, the electrical power output device 80 has output of 5 volts and 1.0 amp (5.0 Watts) for charging an electrical device (e.g., a smartphone). In the illustrative embodiment, there is no built-in battery for storing power. Although, in another embodiment, a battery storage device may be operatively coupled to the solar panel 50 and the electrical power output device 80 so that power generated by the solar panel 50 may be stored, and used at a later time for recharging or powering the electrical device.

It is readily apparent that the aforedescribed portable cooler 100 offer numerous advantages. First of all, the portable cooler 100 is easier to pull and transport to different locations, even when the cooler is loaded with food and/or beverage items. In addition, the portable cooler 100 described herein has a built-in solar panel 50 for powering electronic devices when a user is located at a remote location that does not have conventional power sources.

Any of the features or attributes of the above described embodiments and variations can be used in combination with any of the other features and attributes of the above described embodiments and variations as desired.

Although the invention has been shown and described with respect to a certain embodiment or embodiments, it is apparent that this invention can be embodied in many different forms and that many other modifications and variations are possible without departing from the spirit and scope of this invention.

Moreover, while exemplary embodiments have been described herein, one of ordinary skill in the art will readily appreciate that the exemplary embodiments set forth above are merely illustrative in nature and should not be construed as to limit the claims in any manner. Rather, the scope of the invention is defined only by the appended claims and their equivalents, and not, by the preceding description.

The invention claimed is:

1. A portable cooler, comprising:
a cooler body portion, the cooler body portion defining an interior compartment configured to hold beverages and/or food items;
a cooler lid portion coupled to the cooler body portion, the cooler lid portion operable between open and closed states so as to allow a user to gain access to the beverages and/or food items in the interior compartment; and
a telescopic handle assembly coupled to the cooler body portion, the telescopic handle assembly comprising an upper handle portion and a lower handle portion, the lower handle portion being pivotally coupled to a side wall of the cooler body portion, and the upper handle portion of the telescopic handle assembly being telescopically extendable from the lower handle portion of the telescopic handle assembly so as to facilitate a transporting of the portable cooler by the user.

2. The portable cooler according to claim 1, wherein the cooler body portion defines at least one first handle recess and the cooler lid portion defines at least one second handle recess, and the telescopic handle assembly is pivotably displaceable between a stowed position and an operative position;
wherein, in the stowed position, the telescopic handle assembly is received within the at least one first handle recess in the cooler body portion and the at least one second handle recess in the cooler lid portion; and
wherein, in the operative position, the telescopic handle assembly extends outwardly from the side wall of the cooler body portion so that the telescopic handle assembly is able to be readily grasped by the user.

3. The portable cooler according to claim 1, wherein the upper handle portion of the telescopic handle assembly comprises a release button for disengaging a locking mechanism that prevents the telescopic extension of the upper handle portion from the lower handle portion of the telescopic handle assembly.

4. The portable cooler according to claim 1, wherein the cooler body portion comprises an inner tank portion received within an outer shell portion, a portion of the inner tank portion being spaced apart from the outer shell portion so as to define a cavity therebetween comprising an insulating material, the insulated cavity configured to minimize heat transfer into the interior compartment of the portable cooler.

5. The portable cooler according to claim 4, wherein the inner tank portion is formed using an injection molding process and the outer shell portion is formed using a blow molding process.

6. The portable cooler according to claim 1, wherein the cooler lid portion comprises at least one beverage container recess disposed in a top surface thereof, the at least one beverage container recess configured to receive a base portion of a beverage container so as to prevent the beverage container from being knocked over by the user.

7. The portable cooler according to claim 1, further comprising at least one latching device for maintaining the cooler lid portion in a closed position relative to the cooler body portion, the at least one latching device comprising protruding prong members for allowing the at least one latching device to be used as a bottle opener and/or can opener by the user.

8. The portable cooler according to claim 1, further comprising a pair of lifting handles for facilitating a lifting of the portable cooler by the user, a first one of the lifting handles being disposed on a first end of the cooler body portion, and a second one of the lifting handles being disposed on a second end of the cooler body portion that is opposite to the first end of cooler body portion.

9. The portable cooler according to claim 8, wherein the first one or the second one of the lifting handles is partially circumscribed by the telescopic handle assembly when the telescopic handle assembly is in a stowed position.

10. The portable cooler according to claim 1, wherein the cooler body portion further comprises a removable partition member that divides the interior compartment into a plurality of sub-compartments, and one or more interior walls of the cooler body portion comprise a slot for slidably receiving an edge portion of the removable partition member therein.

11. The portable cooler according to claim 1, wherein the cooler body portion further comprises a removable tray member, a portion of a peripheral edge of the removable tray member configured to be supported on a peripheral ledge disposed on one or more sides of the interior compartment of the cooler body portion.

12. The portable cooler according to claim 1, further comprising at least one wheel disposed near a bottom of the cooler body portion for enabling the portable cooler to be rolled while being transported by the user, the at least one wheel comprising an inner rim portion formed from a first polymeric material and an outer tire portion formed from a second polymeric material, the second polymeric material being more flexible than the first polymeric material.

13. The portable cooler according to claim 1, wherein the cooler body portion has a first end and a second end, the first end of the cooler body portion being oppositely disposed relative to the second end of the cooler body portion, the telescopic handle assembly being disposed on the first end of the cooler body portion and the at least one wheel being disposed proximate to the second end of the cooler body portion;
whereby the user is able to lift up the first end of the portable cooler using the telescopic handle assembly, and then pull the portable cooler along the ground while the second end of the portable cooler is supported on the at least one wheel.

14. The portable cooler according to claim 1, further comprising:
a solar panel disposed on the cooler lid portion, the solar panel configured to generate electrical energy from a light source; and
an electrical power output device electrically coupled to the solar panel, the electrical power output device configured to transmit the electrical energy generated by the solar panel to an electrical device for recharging or powering the electrical device.

15. The portable cooler according to claim 14, wherein the solar panel is recessed mounted on the cooler lid portion such that a top surface of the solar panel is generally flush with a top surface of the cooler lid portion.

16. The portable cooler according to claim 14, wherein the electrical power output device comprises an electrical receptacle configured to receive an electrical connector that is electrically coupled to the electrical device.

17. A portable cooler, comprising:
a cooler body portion, the cooler body portion defining an interior compartment configured to hold beverages and/or food items;
a cooler lid portion coupled to the cooler body portion, the cooler lid portion operable between open and closed states so as to allow a user to gain access to the beverages and/or food items in the interior compartment;
a solar panel disposed on the cooler lid portion, the solar panel configured to generate electrical energy from a light source; and
an electrical power output device electrically coupled to the solar panel, the electrical power output device configured to transmit the electrical energy generated by the solar panel to an electrical device for recharging or powering the electrical device.

18. The portable cooler according to claim 17, wherein the solar panel is recessed mounted on the cooler lid portion such that a top surface of the solar panel is generally flush with a top surface of the cooler lid portion.

19. The portable cooler according to claim 18, wherein the electrical power output device comprises an electrical receptacle configured to receive an electrical connector that is electrically coupled to the electrical device.

20. The portable cooler according to claim 19, wherein the electrical receptacle is in a form of a universal serial bus (USB) port for receiving a USB plug that is coupled to the electrical device by an electrical cord.
